(19) United States
(12) Patent Application Publication
(10) Pub. No.: US 2025/0216661 A1
(43) Pub. Date: Jul. 3, 2025

(54) LIGHT-FIELD TOMOGRAPHIC FLUORESCENCE LIFETIME IMAGING MICROSCOPY (LIFT-FLIM)

(71) Applicant: THE REGENTS OF THE UNIVERSITY OF CALIFORNIA, Oakland, CA (US)

(72) Inventors: Liang Gao, Santa Clara, CA (US); Yayao Ma, Los Angeles, CA (US)

(73) Assignee: THE REGENTS OF THE UNIVERSITY OF CALIFORNIA, Oakland, CA (US)

(21) Appl. No.: 19/007,673

(22) Filed: Jan. 2, 2025

Related U.S. Application Data
(60) Provisional application No. 63/616,967, filed on Jan. 2, 2024.

(51) Int. Cl. G02B 21/00; G01N 21/64

(52) U.S. Cl. CPC G02B 21/008; G01N 21/6408; G01N 21/6458; G02B 21/0032; G02B 21/0048; G02B 21/0076; G01N 2021/6478

(57) ABSTRACT

A light field tomography fluorescence lifetime imaging microscopy (LIFT-FLIM) apparatus with an objective, a field stop, and a fluorescence lifetime imager. The imager includes an array of Dove prisms configured to receive light from the field stop, a plurality of lenslets where each lenslet is optically coupled to at least one Dove prism in the array of Dove prisms, and a plurality of cylindrical lenses that are optically coupled to at least one lenslet, and an image sensor configured to image light received from the cylindrical lenses.

### CROSS-REFERENCE TO RELATED APPLICATIONS

This application claims priority to, and the benefit of, U.S. provisional patent application Ser. No. 63/616,967 filed on Jan. 2, 2024, incorporated herein by reference in its entirety.

### STATEMENT REGARDING FEDERALLY SPONSORED RESEARCH OR DEVELOPMENT

This invention was made with government support under GM128761 awarded by the National Institutes of Health. The government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This technology pertains generally to fluorescence lifetime imaging microscopy techniques and more particularly to a light-field tomographic fluorescence lifetime imaging microscopy (LIFT-FLIM) apparatus and techniques that are capable of producing two-dimensional (2D) or three-dimensional (3D) lifetime images in a highly data-efficient manner. In contrast to current FLIM technologies, LIFT-FLIM drastically reduces the required number of scanning steps to capture the same 2D or 3D images, leading to an accelerated volumetric frame rate. LIFT-FLIM is adaptable across a range of biomedical applications, including label-free cancer imaging and high-throughput, high-content phenotypic screening.

### 2. Background

Fluorescence lifetime imaging microscopy (FLIM) is a powerful imaging technique that enables the visualization of biological samples at the molecular level by measuring the fluorescence decay rate of fluorescent probes. This provides critical information about molecular interactions, environmental changes, and localization within biological systems. Fluorescence lifetime imaging microscopy has been extensively employed in a wide spectrum of biomedical applications, ranging from single cell studies to medical diagnosis.

Rather than imaging the time-integrated fluorescent signals, FLIM measures the time-lapse fluorescent decay. Because the lifetime of a fluorophore is dependent on its molecular environment but not on its concentration, FLIM enables a more quantitative study of molecular effects inside living organisms compared to conventional intensity-based approaches.

However, creating high-resolution lifetime maps using conventional FLIM systems has be challenging, as it often requires extensive scanning that can significantly lengthen acquisition times. This issue is further compounded in three-dimensional (3D) imaging because the process demands additional scanning along the depth axis.

The FLIM techniques are generally stratified into two categories: frequency-domain FLIM and time-domain FLIM. Frequency-domain FLIM illuminates the sample with the frequency-modulated light, driving fluorescence oscillating at the same pace but with a reduced modulation depth and a phase shift as a result of the non-instant fluorescence decay. To extract the phase shift and modulation depth from the fluorescence signals, frequency-domain FLIM modulates the gain of the camera at the same or slightly different frequency as the excitation light. The fluorescence lifetime can then be derived from the measured signals by comparing them to a reference fluorophore with a known lifetime.

In contrast, time-domain FLIM illuminates the sample with pulsed laser excitation, followed by measuring the fluorescent decay in sequential time channels using an ultrafast detector or detector array. Due to the direct measurement of the fluorescence decay, time-domain FLIM is more effective than its frequency-domain counterpart in demultiplexing fluorophores, particularly when the fluorophores exhibit multi-exponential decays. To acquire a two-dimensional (2D) lifetime map, most current time-domain FLIM either scans pointwise like in a confocal microscope or capture a widefield image using a high-speed camera like a gated image intensified CCD (ICCD). Due to the extensive scanning, confocal time-domain FLIM is slow because of the limits of data acquisition. And this problem further escalates in three-dimensional (3D) imaging as it typically takes a prohibitively long time to acquire a volumetric lifetime image. In contrast, widefield time-domain FLIM measures the time-lapse signals of pixels in parallel, allowing a faster frame rate. Nonetheless, to capture a high-resolution image, widefield time-domain FLIM requires a costly large-format gated image sensor, limiting its access to the general research labs.

The emergence of single-photon avalanche diode (SPAD) arrays manufactured with complementary-metal-oxide semiconductor (CMOS) technology provides a solution to low-cost widefield time-domain FLIM. Moreover, SPAD arrays outperform conventional gated cameras with respect to temporal resolution and sensitivity, making them ideal for providing time-domain FLIM. However, for SPADs arranged in a 2D array, the fill factor of each pixel is generally low due to the physical constraints imposed by the need to fit complex timing electronics for each individual pixel, particularly for time-correlated single photon counting (TCSPC) applications. In contrast, a linear SPAD array allows a much greater fill factor (˜80%). Nonetheless, to image a 2D/3D scene with a high-resolution, the system must scan the FOV/volume with many steps, leading to a prolonged acquisition just like in confocal FLIM.

Accordingly, there is a need for improved processes and methods for forming images that will address these challenges.

### BRIEF SUMMARY

An imaging system, apparatus and computational imaging techniques called light field tomographic FLIM (LIFT-FLIM) are provided that allows for the efficient acquisition of volumetric fluorescence lifetime that significantly reduces the number of scanning steps required compared to conventional point-scanning or line-scanning FLIM imagers. Moreover, LIFT-FLIM enables the measurement of high-dimensional data using low-dimensional detectors, which are low-cost and provide a high temporal bandwidth.

A computational imaging technique called Light-Field Tomographic Fluorescence Lifetime Imaging Microscopy (LIFT-FLIM) is used to streamline the acquisition of 3D FLIM data using a linear SPAD array. The approach has been only recently made possible by an adaptation of an emerging technique, light field tomography (LIFT), which is highly efficient in acquiring light field data for 3D imaging. Sharing its roots with light field photography, the LIFT technique acquires multiple views of a 3D object and determines depth information through disparity analysis. However, rather than directly capturing a 2D perspective image, the LIFT method measures only the en-face projections of the image, thereby transforming 2D perspective images into lines. This allows the mapping of high-dimensional optical information to a low-dimensional space through pure optical operations. In LIFT-FLIM, the methods take advantage of this transformation by directly capturing 1D projection images using a linear SPAD array, allowing for 3D fluorescence lifetime imaging with exceptional single-photon sensitivity.

Aside from its impressive 3D imaging capability, LIFT also possesses inherent compatibility with spectral imaging. Capitalizing on this feature, the versatility of the system is highlighted by extending its functionality to include spectral FLIM (sFLIM). This is achieved by dispersing the 1D projection images utilizing a diffraction grating, and then feeding the resulting image into a time-gated camera for precise lifetime measurement. This allows for the simultaneous acquisition of 3D FLIM images at multiple wavelengths, making the system a versatile tool for analyzing both lifetime and spectral information. The apparatus and LIFT-FLIM and LIFT-sFLIM methods were demonstrated on various biological systems and showed their potential for high-content multiplexed imaging.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic depiction of an Image formation model of LIFT-FLIM methods according to one embodiment of the technology.

FIG. 2 is a schematic depiction of an Image formation model of LIFT-sFLIM methods according to one embodiment of the technology.

FIG. 3 is a system diagram of the of LIFT-FLIM 3D microscope with both of LIFT-FLIM and of LIFT-sFLIM imaging according to one embodiment of the technology.

FIG. 4 is a schematic illustration of a deep-learning-based image enhancement neural network.

FIG. 5 is a schematic of the LIFT-FLIM configuration showing the tracing of chief rays at the x-z plane where cylindrical lens has optical power.

FIG. 6 is a schematic of the LIFT-FLIM configuration showing the tracing of chief rays at the y-z plane where cylindrical lens has no optical power.

FIG. 7 is a schematic of the LIFT-FLIM configuration showing the tracing of marginal rays at the y-z plane where cylindrical lens has no optical power.

FIG. 8 is a simplified schematic of the LIFT-FLIM system describing the depth to resolution ratio (DRR).

FIG. 9 is a schematic illustration of a wavelength selection module with a digital micromirror device (DMD).

FIG. 10 is schematic diagram of an inverted microscope configuration with laser excitation and detection system of an image compression unit (ICU) and an image dispersion unit (IDU). Upon excitation, the emitted fluorescence will be collected by the microscope objective lens and directed to the detection part of the system.

FIG. 11 is a diagram of an image compression section of the with a 5×5 array of dove prisms at the relayed back aperture according to an alternative embodiment of the technology.

### DETAILED DESCRIPTION

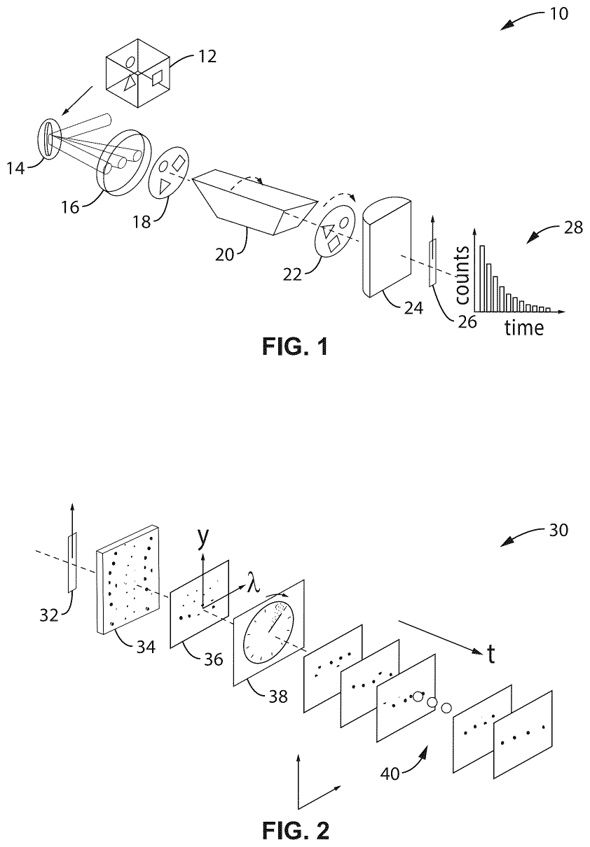

Referring more specifically to the drawings, for illustrative purposes, apparatus and methods for light-field tomographic fluorescence lifetime imaging microscopy (LIFT-FLIM) are generally shown. Several embodiments of the technology are described generally in FIG. 1 to FIG. 11 to illustrate the characteristics and functionality of the apparatus and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

To enable three-dimensional fluorescence lifetime imaging microscopy (3D FLIM) with a single-photon avalanche diode (SPAD) array, a computational imaging method, dubbed light-field tomographic fluorescence lifetime imaging microscopy (LIFT-FLIM), is presented. Rather than directly measuring the time-lapse fluorescence decay at each image point, LIFT-FLIM captures only an en-face projection of a 3D object in each perspective image, transforming a volumetric image into lines. The resultant 1D images can then be directly recorded by a linear single-photon avalanche diode (SPAD) camera for lifetime measurement.

Turning now to FIG. 1 to FIG. 3, the basic principles of the LIFT-FLIM apparatus and imaging methods are generally illustrated schematically. The core function of the image formation model of LIFT-FLIM 10 is to transform and map 3D image information 12 to a 1D linear sensor 26 through a series of optical operations as shown in FIG. 1. A dynamic steering mirror 14 positioned at the image plane tilts the incident 3D scene 12, producing a perspective view 16. This 2D perspective image 18 is then rotated using a Dove prism 20 and optically integrated along the horizontal axis with a cylindrical lens 24. The resulting image 26 is an en-face projection of the perspective view along the orientation set by the Dove prism 20.

Accordingly, LIFT captures only an en-face projection of a 3D object in each perspective image, transforming a volumetric image into lines, rather than directly measuring the irradiance at each image point. This transformed line image can be directly measured by a linear single-photon avalanche diode SPAD camera or further spectrally dispersed and measured by a time-gated camera as shown in FIG. 2. Measurements may be repeated at different steering mirror 14 and Dove prism 20 rotation angles. The measurements can produce a time-correlated single photon counting (TCSPC) temporal histogram 28.

To enable spectral-lifetime multiplex imaging, an ultrafast time gating device 30 may be added to the spectral LIFT system and capture a series of time-gated dispersed projection images. The system can simultaneously image a large number of fluorescent probes for high-content screening, for example. In the embodiment shown in FIG. 2, acquired one-dimensional (1D) images 32 can be further spectrally dispersed and time-gated for simultaneous spectral and lifetime measurements, thereby allowing imaging of a large number of fluorophores at a fast volumetric frame rate. As shown schematically in FIG. 2, the 1D images 32 are directed through a diffraction grating 34 to produce dispersed projection images 36 that are time gated with an ultrafast time gate 38 to produce a set of time-gated dispersed projection images 40.

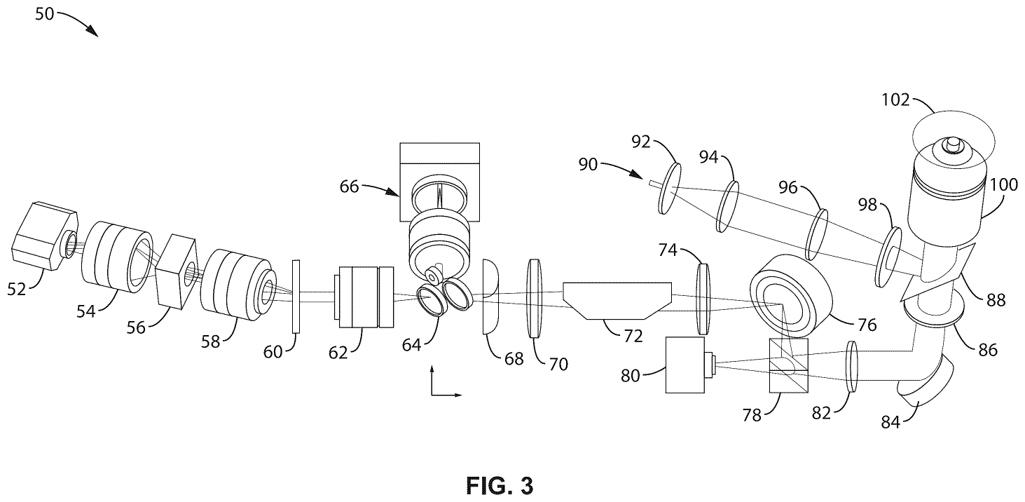

A schematic of one preferred embodiment of the LIFT-FLIM system 50 is shown in FIG. 3, where a sample is excited using a wide-field epi-illumination configuration. The system is generally centered on a spectral-LIFT 3D microscope platform that can acquire high-resolution perspective images by dividing the aperture of the objective lens. These perspective images are then optically transformed into lines, followed by spectrally dispersing the line images using a diffraction grating. The resultant system is able to image a volume of 600×600×200 μm³ with 20 colors at a volumetric frame rate up to 200 Hz.

To expand the system's functionality to fluorescence lifetime imaging, an ultrafast time gating device has been added to the spectral LIFT system that captures a series of time-gated dispersed projection images. The spectral 3D scene is reconstructed at each time point along with the fluorescence decay, leading to a five-dimensional (5D) (x, y, z, λ, t) datacube (x, y, z, spatial coordinates; λ, wavelength; t, time). A spectral-lifetime is then applied combining the power of spectral imaging and FLIM in demultiplexing fluorophores, the resultant system is able to image a large number of biomarkers simultaneously and, thereby, enable high-content screening.

Referring now to the embodiment of the system shown in FIG. 3, the apparatus 50 has both LIFT-FLIM and spectral FLIM (LIFT-sFLIM) sub-systems. The spectral FLIM sub-system uses a 2D ultrafast time-gated camera 52, a camera lens 54, and ultra-fast time gate 56, a camera lens 58, a diffraction grating 60 and a camera lens 62. The LIFT-FLIM sub-system employs a linear SPAD array 66 and a flip mirror 64 is configured to switch the light path between the two sub-systems.

The line image is produced and presented to the two sub-systems and flip mirror 64 from a cylindrical lens 68, a lens 70, a dove prism, a lens 74 and a scanning mirror 76 generally comprising a 4f sub-system.

The front-end optics and sample excitement sub-system has a beam splitter 78, a reference camera 80, a lens 82, a folding mirror, an emission filter 86, a dichroic mirror 86, microscope objective 100 and sample stage 102. The sample excitation subsystem has a laser source 90, an engineered diffuser 92, a first lens 94, as second lens 96 and an excitation filter 98 directing light to the dichroic mirror 86 through the objective 100 to the sample stage 102. The emitted fluorescence is collected by a microscope objective lens, and an intermediate fluorescence image is formed at the side image port of the microscope.

Based on computational imaging, the LIFT-FLIM system 50 generally operates in two steps: data acquisition and image reconstruction. Upon pulsed laser excitation with the laser 90, the fluorescence is collected by a microscope objective lens 100, preferably with a high numerical aperture (NA), and forms an intermediate image at the microscope's side image port. A beam splitter 78 then divides the fluorescence into two beams. The transmitted light is recorded directly by a complementary metal-oxide-semiconductor (CMOS) camera 80, resulting in a reference intensity image.

For image reconstruction, the reflected light of the second beam creates an intermediate image on the scanning mirror 76. As the mirror 76 tilts, it imparts twice its angle of tilt onto the outgoing rays. The reflected light from the scanning mirror is then collimated by a lens 74 and forms a pupil image at a plane, where a dove prism 72 is positioned. By adjusting the tilt angle of the mirror, it is possible to shift the position of the pupil image on this plane. This enables one to selectively direct the light rays corresponding to a specific view angle through the dove prism, which will rotate the light rays and produce a rotated perspective image. Next, a cylindrical lens 68 is used to compress the rotated perspective image into a line, which is essentially an en-face projection of the original perspective image along an orientation twice the rotation angle of the dove prism 72. This transformed line image can be either directly measured by a linear SPAD camera 66 or further spectrally dispersed and measured by a time-gated camera 52.

Image formation of LIFT-FLIM within the context of this system is preferably formulated using a linear model. For a given perspective image Pₖ(u, v), at view k (k=1, 2, . . . , K), the projection measurement along angle θ is

$${f}_{k}^{θ} ( y ) = T {R}^{θ} {P}_{k} , \qquad ( 1 )$$

where Pₖ has a size of N² (u=1, 2, . . . , N; v=1, 2, . . . , N is the image dimension in pixels), T is the en-face projection operator, and Re is the image rotation operator, which describes the function of the dove prism rotated at θ/2. The number of spatial pixels in the 1D projection image is N (y=1, 2, . . . , N).

Rather than capturing a complete set of N projection angles at each view, only a subset of nₖ projection angles at view k are acquired. This process can be explicitly written as:

$$f = [ \begin{matrix}{A}_{1} & … & 0 \\ ⋮ & {A}_{2} & ⋮ \\ 0 & ⋱ & 0 \\ 0 & … & {A}_{K}\end{matrix} ] [ \begin{matrix}{P}_{1} \\ {P}_{2} \\ ⋮ \\ {P}_{K}\end{matrix} ] + σ . \qquad ( 2 )$$

Here f is a stack of projection measurements (also referred to as a sinogram 28 in FIG. 1), and it has a dimension of N×N_{θ} where N_{θ}=Σ₁^{K}nₖ. Aₖ=TR_{K}=T[R^{θ}^{_{k,1}}; R^{θ}^{_{k,2}}; . . . , R^{θ}^{_{k,nk}}] is a combined function of en-face projection and image rotation operators on perspective image Pₖ. σ denotes the measurement noise. Because the images from different views capture the same scene, they share a common underlying content, with only a depth-dependent disparity between any two sub-aperture images that are produced.

Therefore, the correlation between sub-aperture images can be modeled by digitally propagating the light field, i.e. the sub-aperture image Pₖ at view k can be related to a depth-dependent vectorized image h(d) through an invertible shearing operator Bₖ as Pₖ=Bₖ(d)h(d), where Bₖ is also a function of depth d. Accordingly, Eq. 2 above can be transformed to:

$$f = [ \begin{matrix}{A}_{1} & … & 0 \\ ⋮ & {A}_{2} & ⋮ \\ 0 & ⋱ & 0 \\ 0 & … & {A}_{K}\end{matrix} ] [ \begin{matrix}{B}_{1} ( d ) h ( d ) \\ {B}_{2} ( d ) h ( d ) \\ ⋮ \\ {B}_{K} ( d ) h ( d )\end{matrix} ] + σ = [ \begin{matrix}{A}_{1} {B}_{1} ( d ) \\ {A}_{2} {B}_{2} ( d ) \\ ⋮ \\ {A}_{K} {B}_{K} ( d )\end{matrix} ] h ( d ) + σ = F ( d ) h ( d ) + σ \qquad ( 3 )$$

The overall image forward operator F(d) becomes a function of depth d, which is essential for recovering image h(d) with various focal settings. Noteworthily, although individual Pₖ is measured at only a subset of projection angles, the underlying image h(d) is measured on a complete angular basis, as F(d) concatenates image rotation operators across all views.

For direct fluorescence lifetime measurement using a linear SPAD array with TCSPC as illustrated in FIG. 2, the image formation model is a time-lapse version of Eq. 3, which can be expressed as:

$$f ( t ) = F ( d ) h ( d , t ) + σ ( t ) , \qquad ( 4 )$$

where f(t) is a time-lapse sinogram constructed by the projection measurements at the time bin t of a TCSPC temporal histogram.

For spectral FLIM measurement using a gated ultrafast camera 52 shown in FIG. 3, the image forward model is a function of both time t and wavelength λ:

$$f ( t , λ ) = F ( d ) h ( d , t , λ ) + σ ( t , λ ) , \qquad ( 5 )$$

where f(t, λ) is a spectrally resolved, time-lapse sinogram constructed by the projection measurements at the gated time t and wavelength λ.

The image reconstruction of LIFT-FLIM and LIFT-sFLIM involves solving the inverse problems of Eq. 4 and 5 above, respectively. Like standard computed tomography, this can be accomplished through simple inverse Radon transform or more advanced optimization algorithms like a Fast Iterative Shrinkage-Thresholding Algorithm (FISTA).

Akin to conventional light field cameras, LIFT-FLIM and LIFT-sFLIM divide the aperture to extract the depth information. Therefore, they have a reduced lateral resolution (˜1.8 μm) compared with the native diffraction-limited resolution of the objective lens. To improve the quality of the reconstructed images, a deep-learning-based image enhancement neural network can be used. The input to the neural network generally consists of reconstructed LIFT depth images, a diffraction-limited reference image captured at the depth zero, and digital propagation matrices (DPMs), which represent the axial distance from the reference image plane to the target plane on a per-pixel basis. The neural network then uses a PixelCNN++ architecture to generate high-resolution outputs at corresponding depths. With DPMs, the neural network effectively enhances the image quality by reducing out-of-focus blur and refocusing artifacts usually observed in images captured by light field cameras with limited angular sampling rates.

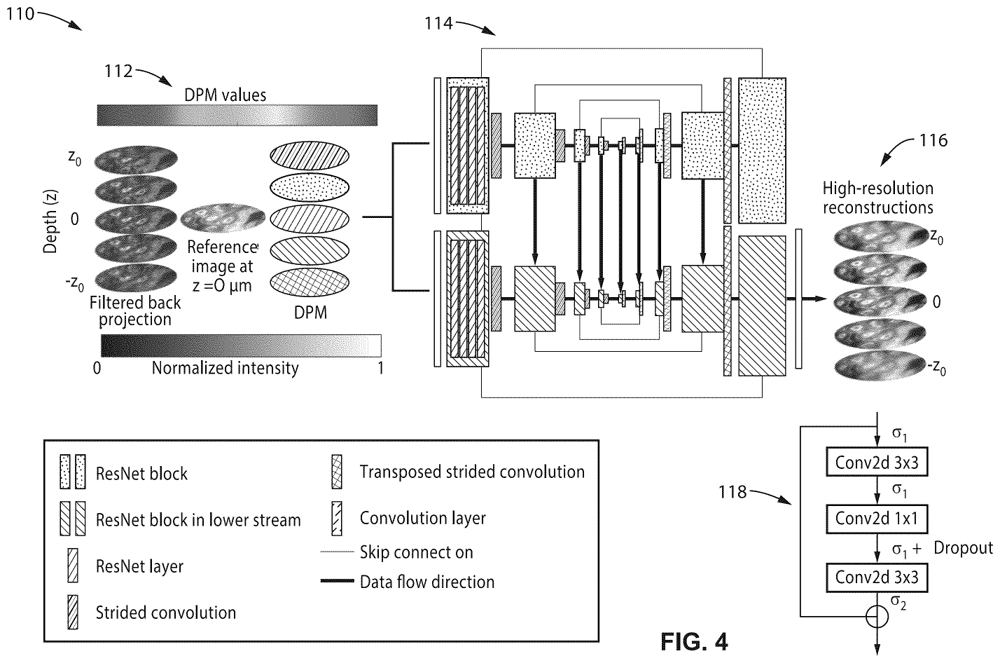

In one embodiment, the imaging system 50 and methods can be augmented with the use of a deep-learning-based image enhancement neural network 110, as seen on FIG. 4. To improve the quality of the reconstructed images, a deep-learning-based image enhancement neural network.

The network 114 is composed of two down- and up-sampling streams. Each stream has five ResNet blocks 112 in both down-sampling and up-sampling paths. Each ResNet block contains four ResNet layers, and each ResNet layer has two 3×3 convolutional layers and one 1×1 convolutional layer, as indicated in the bottom right panel 118. Strided convolutional layers were added between the two adjacent ResNet blocks to halve the spatial dimensions in the down-sampling path, and conversely transposed strided convolutional layers are utilized to implement up-sampling in the up-sampling path.

The spatial dimensions of the ResNet blocks in the sampling streams from left to right are 256×256, 128×128, 64×64, 32×32, 16×16, 32×32, 64×64, 128×128, 256×256. The central 16×16 ResNet blocks are shared by the down-sampling and up-sampling streams. Skip connections connect each ResNet block in the down-sampling path with its counterpart block in the up-sampling path. The inputs to the network include LIFT refocused depth image stack using filtered back projection from depth −z₀, to depth z₀, reference image captured at depth zero, and a DPM stack. The output 118 is a high-resolution image stack 116 at the corresponding depths. DPM: digital propagation matrix. σ₁, σ₂: activation functions. Conv2d: convolution 2D.

Using LIFT-FLIM for 3D lifetime imaging offers a crucial benefit of reducing the number of scanning steps required compared to traditional point- or line-scanning time-domain FLIM techniques. To produce a 3D image of Nₓ×N_{y}×N_{z} voxels, a FLIM system that uses point- or line-scanning requires a total of Nₓ×N_{y}×N_{z} or N_{y}×N_{z} (if line scans are done along the y axis) scanning steps, respectively. Here, Nₓ, N_{y}, and N_{z} denote the number of spatial samplings in a 3D space. For simplicity, Nₓ=N_{y}=N is considered. In contrast, because LIFT-FLIM distributes projection measurements into different views, it demands only N_{θ} scanning steps, where No is a total number of projection angles. Therefore, LIFT-FLIM reduces the scanning steps required by a factor of N²×N_{z}/N_{θ} or N×N_{z}/N_{θ} compared to point- or line-scanning systems.

For non-compressive measurements, N_{θ} is set equal to N. Additionally, in the light field imaging, it has been found that the effective number of depth samplings, N_{z}, equals the number of angular samplings, K. As a result, the scanning reduction factor is either N×K or K when compared to point-system or line-scanning systems. With the current N and K values set at 180 and 15, respectively, the resulting scanning reduction factors are 2,700 and 15 in comparison to point-system or line-scanning systems.

Alternatively, like sparse-view computed tomography, a N_{θ} can be chosen to be less than N for compressive measurements. Therefore, a compression ratio (CR) can be defined as:

$$C R = N / {N}_{θ} . \qquad ( 6 )$$

In the compressive imaging framework, the number of measurements required to reconstruct the image can be substantially reduced. However, the image reconstruction fidelity depends on the CR and the sparsity of the image. Generally, the image must be compressible, so that it can be sparsely represented on a certain basis. Under this condition, a basis-pursuit method may be used to reconstruct the image by finding its sparse representation.

To quantify the dependence of the reconstructed image quality on the CR, the peak signal-to-noise ratio (PSNR) and structural similarity index measure (SSIM) can be adopted as evaluation metrics. The CR can be varied by increasing N_{θ} and calculated the corresponding PSNRs and SSIMs.

In general, reducing the CR improves both PSNR and SSIM in the reconstructed image. Additionally, it was found that the quality of the reconstructed image is highly dependent on the CR for complex objects, like the lung tumor images. In such cases, a lower CR value, less than 4.5, is necessary to achieve high-quality image reconstruction (SSIM≥0.9).

Conversely, when imaging a sparse object, such as an USAF resolution target, a CR of 9 is sufficient to recover a high-quality image. Therefore, by adjusting N_{θ}, LIFT-FLIM can tailor the CR to the complexity of a sample, resulting in effective measurements for a given object.

The Imaging speed of LIFT-FLIM is determined by the total number of projections N_{θ} acquired and the time duration at each projection. For LIFT-FLIM using a linear SPAD array, the duration at each projection includes both the pixel exposure time and temporal histogram readout time.

For the LIFT-sFLIM system using a gated ultrafast camera, the duration at each projection equals the product of the number of time gates and the camera frame time. Importantly, when imaging simple objects, the system can be operated in the compressive measurement mode, where a reduced N_{θ} can be acquired to accelerate the imaging speed without compromising the image quality.

The spatial resolution of LIFT-FLIM is fundamentally limited by optical diffraction when performing non-compressive measurements. Due to the division of the aperture, LIFT-FLIM has a lateral resolution of λf/D, where λ is the wavelength, f is the focal length of the objective lens, and D is the sub-aperture diameter associated with a perspective image. Given K views, D=D₀/\sqrt{K}, where D₀ is the original aperture of the objective lens. Therefore, the lateral resolution is \sqrt{K} times greater than the native resolution of the objective lens. Although this is a common issue encountered by all light field cameras, it can be mitigated by acquiring fewer views and increasing the sub-aperture size to enhance the resolution at the expense of reduced depth accuracy.

On the other hand, when performing compressive measurements, the spatial resolution of LIFT-FLIM is practically limited by the CR. While a higher CR is favored in terms of imaging speed, it deteriorates the reconstructed image quality and resolution for complex objects. Hence, selecting an appropriate CR value for a given object involves striking a balance between imaging speed and resolution.

LIFT-FLIM images can be reconstructed and analyzed in real-time. For instance, when processing uncompressed measurement data, a simple inverse Radon transform takes about 0.13 seconds per time bin on an Nvidia RTX3080Ti GPU with CUDA. Subsequently, deep learning enhancement and phasor analysis require 0.079 and 0.024 seconds, respectively. Parallel computing reduces the total post-processing time to less than 0.3 seconds.

The light throughout of LIFT-FLIM depends on the sub-aperture size of a perspective image, the ratio of projection line image width to the detector pixel's size, and the fill factor of the image sensor. Because the LIFT-FLIM is built on an unfocused light field imaging configuration, where the projection line width at the image sensor equals to the sub-aperture diameter, D, multiplying with a pupil demagnification ratio, r. Given the pixel pitch, p, and fill factor, κ, the percentage of light measured by the image sensor pixel is

$${ζ}_{FLIM} = \frac{D}{{D}_{0}} \times \frac{p κ}{D r} = \frac{p κ}{{D}_{0} r} . \qquad ( 7 )$$

Here D/D₀ describes the light loss due to the view selection during pupil scanning, where D₀ is the original aperture of the objective lens. Therefore, a lower pupil demagnification ratio (i.e., a shorter focal length of the cylindrical lens 24 shown in FIG. 1) can lead to a higher system light throughput. In the current system, due to use of only off-the-shelf optics and a SPAD array, the r was set to be equal to 0.1, resulting in an overall light throughput of 0.01.

To further enhance the system performance, one possible approach is to utilize custom optics that feature a lower pupil demagnification ratio, r, together with a rectangularly shaped SPAD pixel that has a longer pixel pitch, p, in the direction of the projection line width. Alternatively, instead of scanning the pupil to choose the views, it is possible to simultaneously capture all perspective images by employing an array of dove prisms with different orientations, as previously demonstrated. However, this setup necessitates the use of multiple linear SPAD arrays, each of which measures a projection line image in a synchronized fashion.

On the other hand, for LIFT-sFLIM using a gated ultrafast camera, the light throughput is determined by the sub-aperture size of a perspective image, the diffraction efficiency of the grating, χ, and quantum efficiency of the gated ultrafast camera, η.

$${ζ}_{sFLIM} = \frac{D}{{D}_{0}} \times χ \times η . \qquad ( 8 )$$

Since D/D₀=1/\sqrt{K}, where K is the total number of views acquired, Eq. 8 can be rewritten as ζ_{sFILM}=χη/\sqrt{K}. Hence, reducing the number of angular samplings can boost the light throughput, but this comes at the cost of decreased depth accuracy. Noteworthily, here the pupil magnification ratio, r, has no effect on the light throughput. Rather, it governs the spectral resolution of the system like that of a conventional “push broom” imaging spectrometer.

To investigate how the number of photons received at a pixel affects the quality of the reconstructed image, simulations were conducted under a shot-noise-limited condition. Provided that the pixel with the maximum count in the image collects M photons, the corresponding shot noise is \sqrt{M} photons.

Photon noise can be introduced to all pixels in the projection images and reconstructed the images with various values of M, while maintaining a constant number of projections across all data points in the plot. Reconstruction results of a Shepp-Logan phantom under different M values indicate that a larger M (i.e., more photons) can lead to a higher PSNR. For high-quality image reconstruction with a criterion of PSNR≥20 dB (58-60), M should be greater than 64 photons.

A fundamental limit for LIFT-FLIM's acquisition speed is the SPAD sensor's dead time, during which the sensor does not respond to subsequent photons after the initial photon counting event. When the photon rate is high, photons arriving within the sensor's dead time are discarded, causing the lifetime decay curve to appear shorter which is a phenomenon known as the “pile-up effect.” To mitigate this issue and prevent counting loss, the excitation intensity at the sample is controlled, setting the average photon counting rate at each scanned position to a small fraction (<10%) of the photodetector's maximum photon counting rate (the inverse of its dead time).

Additionally, the compressed measurement reduces the total number of acquisitions, thereby lowering the light dosage to the sample. This is particularly beneficial for 3D imaging, where conventional point-scanning systems require additional scanning along the depth axis. Moreover, wide-field illumination helps reduce phototoxicity. Previous literature suggests that phototoxicity exhibits a nonlinear dependence on laser peak power. By maintaining the same total light dosage, phototoxicity in live cells can be minimized by lowering the peak power and increasing the exposure time.

Lastly, although LIFT-FLIM offers efficient 3D lifetime image acquisition, it lacks intrinsic optical sectioning like confocal or light sheet microscopes. Although 3D deconvolution can possibly remove out-of-focus light, this process is sensitive to the signal to noise ratio and persistent shot noise can degrade in-focus image contrast.

Neural networks with DPM provide an improved 3D imaging quality but require high-fidelity training dataset. Another solution could be combining LIFT-FLIM with structured illumination like light sheets; however, this approach would entail the need for depth scanning, consequently elongating the overall acquisition time-frame. The enhanced optical sectioning capabilities of the methods were compared to conventional wide-field imaging by utilizing 3D image reconstruction algorithms. However, this improvement comes at the expense of increased computational burden due to the iterative reconstruction process.

Capitalizing on its rapid 3D lifetime acquisition capabilities, LIFT-FLIM can find many applications in biomedical sciences. One specific area is high-throughput label-free metabolic imaging of organoids, where FLIM has a unique advantage in examining endogenous metabolic biomarkers like NAD(P)H and FAD. However, the current FLIM techniques stumble in high-throughput screening due to their slow acquisition speed. The LIFT-FLIM process can address this challenge by offering a rapid means to evaluate the subject metabolism in 3D. The technological advancement it affords can expedite endeavors like drug discovery and personalized medicine across diverse fields.

The apparatus, systems and methods provide a highly data-efficient 3D FLIM technique that relies on light field tomography and extended its capabilities to 3D sFLIM. The LIFT-FLIM and LIFT-sFLIM imaging should find broad applications in high-throughput and high-content imaging of biological cells and tissues, opening up new avenues for both fundamental and translational biomedical research.

The technology described herein may be better understood with reference to the accompanying examples, which are intended for purposes of illustration only and should not be construed as in any sense limiting the scope of the technology described herein as defined in the claims appended hereto.

### Example 1

To demonstrate the functionality of the apparatus and imaging system, a system with LIFT-FLIM and LIFT-sFLIM functionalities was constructed configured as shown in FIG. 3 and tested. In the LIFT-FLIM and LIFT-sFLIM system 50, an epi-fluorescence microscope (IX83, Olympus) was used as the front-end optics and the sample was excited with a pulsed laser source 90 (SuperK FIANIUM, FIU-15, NKT Photonics, for LIFT-FLIM; SIRIUS GR-2) and a spark laser 90 was used for LIFT-sFLIM). The emitted fluorescence was collected by a microscope objective lens (UPLXAPO60XO, Olympus; UPLXAPO20X, Olympus), and an intermediate fluorescence image was formed at the side image port of the microscope.

To split the light, a beam splitter (BSX16, Thorlabs) 78 was used, which transmits 10% of the light to a reference camera (CS2100M-USB, Thorlabs) and reflects 90% of the light to the LIFT-FLIM camera. A scanning mirror (MR-10-30, Optotune) 76 was placed at the intermediate image plane to shift the pupil image.

The fluorescence was then directed through a 4f system, which consisted of two lenses (ACT508-250-A and AC254-150-A, Thorlabs) with a focal length of 250 mm and 150 mm, respectively. To rotate the perspective image, a Dove prism 72 (PS990M, Thorlabs) was mounted on a motorized rotation stage (PRM1Z8, Thorlabs) and positioned the assembly at the Fourier plane of the 4f system. A cylindrical lens 68 (LJ1095L1-A, Thorlabs, invariant axis along the y-axis) was also positioned 131 mm after the second lens 70 in the 4f system, which generates a 1D en-face projection of a perspective image along the y-axis. To locate the projection line image, the line with the smallest width was identified. Additionally, the focal shift and spherical aberration introduced by the cylindrical lens 68 is compensated by defocusing.

The subsequent system was split into two arms, namely the LIFT-FLIM and LIFT-sFLIM arms. The former employs a linear SPAD array 66, while the latter utilizes a 2D ultrafast time-gated camera (high-rate image intensifier, LaVision) 52. To switch the light path between the two arms, a flip mirror (TRF90, Thorlabs; PF10-03-G01, Thorlabs) 64 was placed at the line image plane.

When the flip mirror 64 is positioned in the first position 1, the fluorescence is directed towards the LIFT-FLIM sub-system through a camera lens (YN100 mm F2, YONGNUO) and directly measured by the linear SPAD camera 66. The linear SPAD camera 66 comprised 256 effective CMOS SPAD pixels with a pitch of 26.2 μm. Operating in the TCPSC mode, the SPAD camera 66 provided a temporal resolution of 50 picoseconds. It is connected to a FPGA (Spartan 6, Xilinx) with 64 time-to-digital converters (TDCs) and histogram engines, enabling it to process up to 8.5 giga-photons per second. By rotating the dove prisms 72 in a set of angles at assigned views, it is possible to sequentially acquire the 1D en-face projections and construct a sinogram.

In position 2 of the flip mirror 64, the emitted fluorescence is directed to the LIFT-sFLIM sub-system. The line image was relayed to the image sensor plane by a pair of camera lenses (YN100 mm F2, YONGNUO) 54, 58. To disperse the line image along the x-axis, a transmission diffraction grating (GT50-03, Thorlabs) 60 was positioned at the Fourier plane of the relay system. The resultant dispersed projection image was then sampled in time by an ultrafast time gate and further relayed to a 2D camera (CS2100M-USB, Thorlabs) 52 by a camera lens (YN100 mm F2, YONGNUO). By varying the delay between the time gate 56 and the laser reference signal, a series of time-resolved dispersed projection images are acquired. To synchronize the scanning mirror 76, the dove prism rotation stage 72, the camera 52, and the laser 90, a digital delay generator (DG645, Stanford Research Systems) was used. To maximize information content for image reconstruction, the dove prism rotation angles were chosen from a set of angles that are evenly spaced in the range of [0, 90°].

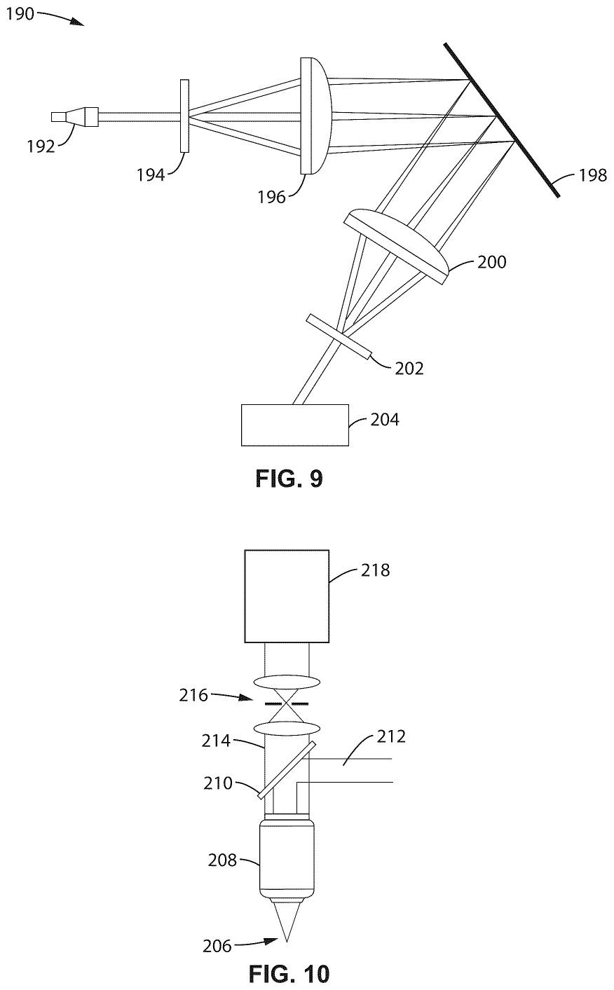

To tune the illumination wavelength from the supercontinuum laser 90, a wavelength-selecting module was built using a digital micromirror device (DMD). A schematic of a wavelength selection module 190 with DMD is shown in FIG. 9. There, the laser source is directed through a beam expander 192 and grating 194 to a first cylindrical lens 196 to at digital micromirror device 198. Dispersed beams from the DMD are directed to a second cylindrical lens 200 and second grating 202 to the LIFT-FLIM.

Using the module, the collimated white laser beam was first dispersed by a transmission diffraction grating (GT50-03, Thorlabs) 60 and line focused onto the surface of the DMD (DLP LightCrafter 6500, Texas Instruments) through a cylindrical lens (LJ1125L1-A, Thorlabs) 68. The broadband illumination had a line dispersion of 54.4 nm/mm on the DMD surface. The DMD has 1920×1080 micromirrors, each of which can be individually tilted ±12° relative to the norm. Each column of the DMD corresponds to a different wavelength with a 0.4 nm/column wavelength resolution. By adjusting the mirror pattern, it is possible to select any desired illumination wavelengths. The laser light of selected wavelengths was then spatially recombined by another identical set of cylindrical lens and diffraction grating and directed towards the LIFT-FLIM sub-system.

When imaging the mixed fluorescence beads and mouse kidney tissue section, for example, a multiband excitation was used with two different wavelengths (488 nm and 561 nm) and separated fluorescence from excitation using the combination of a multiband dichroic mirror (ZT405/488/551/647rpc, Chroma) and a multiband emission filter (ZET405/488/561/647m, Chroma). For imaging the human lung cancer pathology slide, a 450 nm laser excitation was used along with a 495 nm dichroic mirror (T495lpxr, Chroma), and a long-pass emission filter (ET500lp, Chroma). In the case of lung organoids, a 532 nm laser excitation was used along with a 532 nm dichroic mirror (ZT532rdc, Chroma), and a long pass emission filter (ET542lp, Chroma). The laser fluence at the sample focal plane was approximately 9.9×10⁻⁷ J/cm², 1.1×10⁻⁷ J/cm², and 2.9×10⁻³ J/cm² for the mouse kidney section, lung cancer pathology slide, and lung organoid imaging experiments, respectively. These laser fluences were well below the cell damage threshold of 4 J/cm².

### Example 2

To generate the ground truth depth image stack, the sample stage was translated along the depth axis while capturing images using the reference camera. The resulting image stack was then transformed to the LIFT-FLIM and LIFT-sFLIM camera coordinates using a homography matrix obtained through camera registration. The background image was subtracted from the warped image stack.

The LIFT-FLIM and LIFT-sFLIM images were captured at depth=0, and a depth image stack was computed by numerical refocusing. The image stack was reconstructed using an inverse Radon transform with filtered back projection, a widely used method for reconstructing images from sinograms. Specifically, a Ram-Lak filter was applied to the sinogram before performing the back projection. While filtered back projection does not provide an entirely accurate solution due to the ill-posed nature of the problem, it offers a significant reduction in computational cost compared to iterative reconstruction methods.

A uniform DPM was calculated at each depth and then appended to the reconstructed image stack. Then, a mask was created by setting a threshold to the reconstructed image to identify regions with sample fluorescence signals above the background. This mask was then applied to both the ground truth image stack and the LIFT-FLIM and -sFLIM image stack. For training, a total of 200 image stack pairs per task were constructed in the training dataset, each comprising an input image collection (LIFT-FLIM/sFLIM reconstruction stack, DPM stack, and a wide-field image at depth=0) and a ground-truth image stack.

The PixelCNN++ architecture was adopted for LIFT-FLIM and LIFT-sFLIM refocusing. As illustrated in FIG. 4, the model consists of the down- and up-sampling streams and the lower down- and up-sampling streams. Each stream has 5 ResNet blocks in both the down-sampling and up-sampling paths. Each ResNet block contains 4 ResNet layers, and each ResNet layer has two 3×3 convolutional layers and one 1×1 convolutional layer. The ResNet layer utilized two activation functions σ₁, σ₂ defined below:

$${σ}_{1} ( x ) = E L U ( x ⊕ ( - x ) )$$

$${σ}_{2} ( {x}_{1} ⊕ {x}_{2} ) = {x}_{1} ⊙ Sigmoid ( {x}_{2} ) .$$

Here ⊕ means concatenation along the channel axis and ⊙ is element-wise multiplication. Exponential Linear Unit (ELU) and Sigmoid function are defined as

$$E L U ( x ) = \{ \begin{matrix}x , & for x > 0 \\ α ( exp ( x ) - 1 ) , & for x \leq 0\end{matrix} ,$$

$$Sigmoid ( x ) = \frac{1}{1 + exp ( - x )} ,$$

where α is a hyperparameter that controls the value to which an ELU saturates for negative net inputs. Strided convolutional layers were added between two sequential ResNet blocks to halve the spatial dimensions in the down-sampling path, and conversely transposed strided convolutional layers were utilized to implement up-sampling in the up-sampling path. Skip connections connect each ResNet block in the down-sampling path with its counterpart block in the up-sampling path such that relatively higher-frequency image features can flow through the model.

The training loss of our model is a linear combination of Fourier domain mean absolute error (FDMAE), mean square error (MSE) and the perceptual loss:

$$L ( y , \hat{y} ) = α {L}_{FDMAE} ( y , \hat{y} ) + β {L}_{M S E} ( y , \hat{y} ) + γ {L}_{p} ( y , \hat{y} ) .$$

Here α, β and γ are weights of each loss term, and were empirically set as 0.1, 0.1 and 1.0, respectively. y, ŷ∈R^{N}^{²} are the vectorized ground truth and predicted images, respectively. The FDMAE loss is defined as

$${L}_{FDMAE} ( y , \hat{y} ) = {‖ Fy - F \hat{y} ‖}_{1} ,$$

where F∈R^{N}^{²} is the Fourier transform matrix. The MSE loss is defined as:

$${L}_{M S E} ( y , \hat{y} ) = {‖ y - \hat{y} ‖}_{2} .$$

The perceptual loss is defined as the sum of MSE losses between the feature maps of y and ŷ generated by a Visual Geometry Group 16 (VGG16) network:

$${L}_{p} ( y , \hat{y} ) = {\sum }_{k = 1}^{K} {w}_{k} \cdot {‖ {VGG}_{k} ( y ) - V G {G}_{k} ( \hat{y} ) ‖}_{2} ,$$

where VGGₖ(⋅) represent the feature map of the input image after the kth block of VGG16, and wₖ is the weight for the corresponding feature maps. In this work, the first three blocks of VGG16 were used for image feature extraction, i.e., K=3, and empirically set w₁=0.5, w₂=0.15, w₃=0.1. An Adam optimizer with exponentially decaying learning rate was utilized for parameter optimization. The initial learning rate was set as 10⁻⁴ and the decay rate was 0.999995 per epoch.

The models were implemented using PyTorch framework on a machine with Intel Xeon W-2195 processor and four RTX 2080Ti graphic cards. All models converged after around 5000 epochs, which took approximately 2 to 3 days.

### Example 3

As shown in the image formation model and system (FIG. 2 and FIG. 3), the perspective image P passes through a 4f imaging system with a dove prism located at the Fourier plane. The clear aperture of the dove prism thus serves as the system stop. The dove prism rotates P by an angle of 2θ, where θ is the rotation angle of the dove prism itself. Then, the rotated P is imaged by a cylindrical lens that generates a 1D en-face projection at the angle of 2θ along the y-axis and relays the system stop along the x-axis simultaneously.

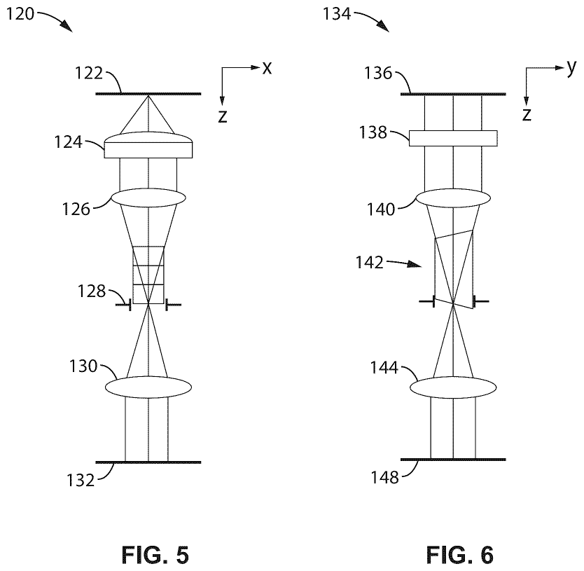

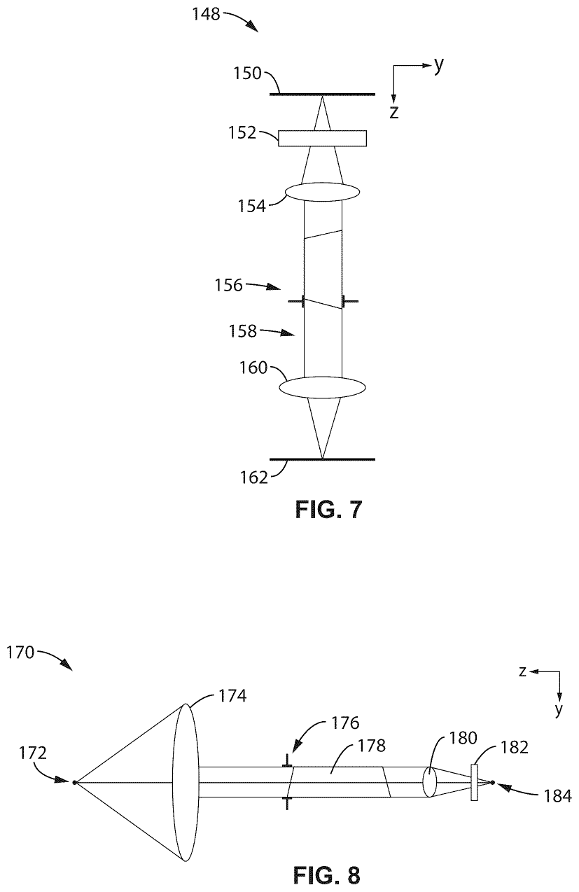

The tracing of chief and marginal rays in the x-z and y-z planes is illustrated in FIG. 5, FIG. 6 and FIG. 7. The LIFT-FLIM configuration showing the tracing of chief rays at the x-z plane where cylindrical lens has optical power is shown in FIG. 5, the tracing of chief rays at the y-z plane where cylindrical lens has no optical power is shown in FIG. 6 and the tracing of marginal rays at the y-z plane where cylindrical lens has no optical power is shown in FIG. 7.

As shown in FIG. 5, the perspective image 132 is directed to with lens 130 to the dove prism/stop 128. At the x-z plane 122 where the cylindrical lens 124 has optical power (FIG. 5), the chief rays emitted from the stop location 128 are collimated by the lens 126 and focused by the cylindrical lens 124 onto the projection image plane 122. The resultant images along the x-axis are essentially the system pupil image.

In the configuration 134 shown in FIG. 6, the perspective image 146 is directed to the dove prism/stop 142 through lens 144. Emitted rays from the prism/stop 142 pass-through lens 140 and cylindrical lens 138 to the projection image plane 136. At the y-z plane where the cylindrical lens 138 has no optical power, the collimated chief rays from lens 140 pass through the cylindrical lens 138 without being refracted and form an image of P along the y-axis. Therefore, the projection image plane is conjugate to P plane along the y-axis while conjugate to the pupil plane along the x-axis. This configuration is referred to as unfocused LIFT, following the convention in light field photography.

The configuration 148 shown in FIG. 7 shows the tracing of marginal rays 158 from the perspective image 162 through lens 160, dove prism/stop 156, lens 154 and cylindrical lens 152 to the projection plane 150. The marginal rays are shown at the y-z plane where the cylindrical lens has no optical power.

The simplified schematic of the LIFT-FLIM system of FIG. 8, shows an object point 184 (point O), an object lens 174 (f₀, D₀), a stop 176, dove prism 178, a second lens 180 (f₁, D₁), a cylindrical lens 182, and an image point 184 (point O′). The f₀ and D₀ are the focal length and aperture of objective lens, respectively. The f₁ and D₁ are the focal length and aperture of second lens 180. Here the D₁ is considered to equal the stop size. Given D₀/D₁=N, the total number of sub-apertures (i.e., angular samplings) is approximately N².

The lateral resolution in the image space is:

$$Δ {x}^{′} = \frac{0.5 \cdot λ}{{NA}^{′}} = λ \cdot \frac{{f}_{1}}{{D}_{1}} ,$$

where λ is the wavelength of light, and NA′=D₁/2f₁ is the numerical aperture of the second lens 180. From Δx′, one can calculate the lateral resolution Δx in the object space as:

$$Δ x = Δ {x}^{′} \cdot \frac{{f}_{0}}{{f}_{1}} = λ \cdot \frac{{f}_{0}}{{D}_{1}} .$$

On the other hand, the axial resolution, δz, is determined by the native aperture of the objective lens:

$$δ z = \frac{0.5 \cdot λ}{{NA}^{2}} = \frac{0.5 \cdot λ}{{( {D}_{0} / 2 {f}_{0} )}^{2}} .$$

In contrast, the depth range, Δz, in the object space is determined by the aperture of the second lens 180:

$$Δ z = \frac{0.5 \cdot λ}{{( {D}_{1} / 2 {f}_{0} )}^{2}} .$$

The depth to resolution ratio (DRR) is defined as the ratio of the extended depth range to the axial resolution, representing the effective number of samplings along the depth axis. The DRR in the LIFT-FLIM system thus can be computed as:

$$DRR = \frac{Δ z}{δ z} = {( \frac{{D}_{0}}{{D}_{1}} )}^{2} = {N}^{2} .$$

### Example 4

An alternative optical setup of the LIFT-FLIM imager with a dove prism array, an image compression unit and an image dispersion unit was built and tested. As illustrated schematically in FIG. 10, the system was centered on an epifluorescence microscope 208 that excites the sample 206 using a pulsed laser source 212 and a dichroic mirror 210. Upon excitation, the emitted fluorescence 214 was collected by a microscope objective lens (focal length, 9 mm; NA, 1; Olympus XLUMPLFLN20XW Objective) 208. A 1:1 4f relay system was used to relay the back aperture of the objective lens to an accessible plane, and an iris is placed at the Fourier plane of the 4f system as a field stop 216. The image detection system 218 had an image compression unit (ICU) and an image dispersion unit (IDU). The ICU collimated the intermediate image at the field stop 222, followed by passing the light to a 5×5 array of dove prisms at the relayed back aperture.

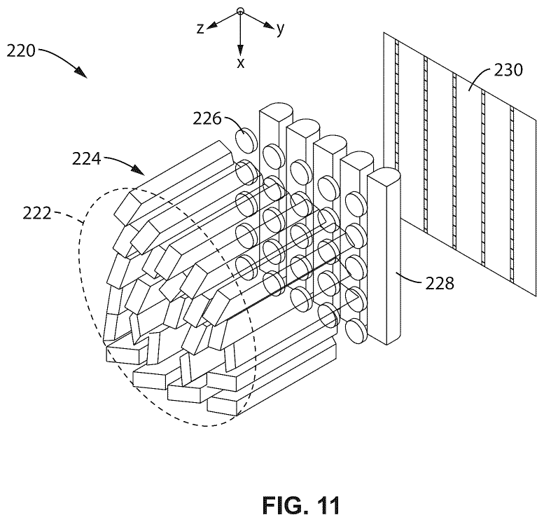

Referring also to FIG. 11, at the relayed back aperture plane 222, a 5×5 array of dove prisms 224, each with a clear aperture 226 of 2 mm and being rotated at a distinct angle around its optical axis. The dove prism rotates the input perspective image by an angle of 2θ, where θ is the rotation angle of the dove prism itself. The e was chosen from a set of angles that are evenly spaced in the range [0, 90°] to maximize information content for image reconstruction.

As seen in FIG. 11, the rotated perspective images were imaged by a combination of a 5×5 array of lenslets 226 (focal length, 30 mm; clear aperture diameter, 2 mm) and a 5×1 array of cylindrical lenses 228 (focal length, 2 mm; clear aperture, 2×10 mm²), where each cylindrical lens 228 covers five lenslets 226. At the x-z plane where the cylindrical lens has no optical power, the chief rays emitted from each sub-pupil location are collimated by the lenslet 226, pass through the cylindrical lens 228 without being refracted, and form an image of the object along the x-axis onto a SPAD camera. In contrast, at the y-z plane where the cylindrical lens has the optical power, the collimated chief rays are focused by the cylindrical lens onto the slit array 230 to the camera. The resultant images along the y-axis are essentially the exit pupil images of corresponding sub-pupils at the back aperture of the objective lens, and each image has a width of ˜100 μm along the y-axis.

The lateral resolution of the LIFT-FLIM microscope was determined by the aperture of the lenslet on the array as shown in FIG. 11. Given an aperture diameter D=2 mm, the lateral resolution is estimated as λ(f/D)≈2 μm, where λ is the wavelength, and f is the focal length of the objective lens. The axial resolution is provided by LIFT's numerical refocusing. For point objects, the axial resolution is calculated as λ/[NA]\hat{ }2≈0.5 μm, where NA is numerical aperture of the objective lens. The system's lateral FOV was limited by the field stop in the 4f relay system, and it is set to be approximately 400 μm to avoid the crosstalk between the adjacent imaging channels on the array. Because of division of the aperture, LIFT offers an extended depth-of-field (about 60 μm), leading to an imaging volume of 400×400×60 μm³.

To calibrate the depth measurement of the LIFT-FLIM camera, a pinhole was placed at the front focal plane of the objective lens, scan the pinhole along the depth axis in the range of ±30 μm with a 0.5 μm step, and capture an image at each depth. Next, the pinhole image captured at each depth was digitally refocused, where the best focal setting can be found by maximizing a focus measure (sum of modified Laplacian) for the pinhole image. Finally, the corresponding shearing parameters were recorded, and a lookup table was built.

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation to a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A light field tomography fluorescence lifetime imaging microscopy (LIFT-FLIM) apparatus, comprising: (a) an objective; (b) a field stop; (c) a fluorescence lifetime imager, the imager comprising: (1) an array of Dove prisms configured to receive light from the field stop; (2) a plurality of lenslets, each lenslet optically coupled to at least one Dove prism of the array of Dove prisms; (3) a plurality of cylindrical lenses, the cylindrical lenses optically coupled to at least one lenslet; and (4) an image sensor configured to image light received from the cylindrical lenses.

The apparatus of any preceding or following implementation, further comprising an excitation light source and a dichroic mirror disposed between the objective and the field stop.

The apparatus of any preceding or following implementation, wherein the image sensor comprises one or more linear SPAD arrays.

The apparatus of any preceding or following implementation, the image sensor further comprises: a first camera lens; a diffractive grating; a second camera lens; an ultrafast time gate; a third camera lens; and a 2D camera.

The apparatus of any preceding or following implementation, further comprising: a processor configured to control the lenses and imaging device; and a non-transitory memory storing instructions executable by the processor; wherein the instructions, when executed by the processor, perform steps comprising: acquiring a dataset of image data from the fluorescence lifetime imaging device over time; and analyzing the acquired dataset.

The apparatus of any preceding or following implementation, wherein the instructions when executed by the processor further perform steps comprising controlling the target illumination light source; and controlling the rate of image data acquisition.

A light field tomography fluorescence lifetime imaging microscopy (LIFT-FLIM) apparatus, comprising: (a) a sample platform; (b) an objective; (c) image compression unit (ICU); and (d) an image dispersion unit (IDU) optically coupled to the ICU.

The apparatus of any preceding or following implementation, further comprising a field stop disposed between the objective and the image compression unit.

The apparatus of any preceding or following implementation, wherein the image compression unit (ICU) comprises: a scanning mirror; a first lenslet; a rotatable Dove prism configured to receive light from the field stop by the scanning mirror through the first lenslet; a second lenslet optically coupled to the rotatable Dove prism; and a cylindrical lens, the cylindrical lenses optically coupled to the second lenslet.

The apparatus of any preceding or following implementation, wherein the image compression unit (ICU) comprises: an array of Dove prisms configured to receive light from the field stop; a plurality of lenslets, each lenslet optically coupled to at least one Dove prism of the array of Dove prisms; a plurality of cylindrical lenses, the cylindrical lenses optically coupled to at least one lenslet; and a slit array.

The apparatus of any preceding or following implementation, wherein the image dispersion unit (IDU) comprises: a first relay lens optically coupled to the slit array of the ICU; a diffraction grating; a second relay lens, the diffraction grating disposed between the first relay lens and the second relay lens; and an imaging device.

The apparatus of any preceding or following implementation, further comprising: a processor configured to control the lenses and imaging device; and a non-transitory memory storing instructions executable by the processor; wherein the instructions, when executed by the processor, perform steps comprising: controlling the target illumination light source; and controlling the image compression unit (ICU); controlling the image dispersion unit (IDU); controlling the acquisition of data; and analyzing an acquired dataset.

The apparatus of any preceding or following implementation, wherein the processor further performs the step comprising: displaying images derived from the analyzed dataset on a display.

A light field tomography fluorescence lifetime imaging microscopy (LIFT-FLIM) system, comprising: (a) a sample excitation subsystem of a microscope objective, laser source and a field stop; (b) an image compression subsystem of a scanning mirror, a first lens, a moveable dove prism, a second lens and a circular lens; (c) an imaging subsystem with an image sensor; (d) a processor configured to control the lenses and imaging device; and (e) a non-transitory memory storing instructions executable by the processor; (f) wherein the instructions, when executed by the processor, perform steps comprising: (i) acquiring a dataset of image data from the imaging device over time; and (ii) analyzing the acquired dataset.

The system of any preceding or following implementation, wherein the sample excitation subsystem comprises: a microscope objective; a laser source of a pulsed laser, a diffuser, a first lens, a second lens; and an excitation filter; a dichroic mirror; and an emission filter.

The system of any preceding or following implementation, the sample excitation subsystem further comprises: a reference camera; a beam splitter optically coupled to a lens and to an emission filter and to the reference camera configured to produce a reference intensity image; and a scanning mirror.

The system of any preceding or following implementation, wherein the image compression unit (ICU) comprises: an array of Dove prisms configured to receive light from the field stop; a plurality of lenslets, each lenslet optically coupled to at least one Dove prism of the array of Dove prisms; a plurality of cylindrical lenses, the cylindrical lenses optically coupled to at least one lenslet; and a slit array.

The system of any preceding or following implementation, wherein the imaging subsystem comprises one or more linear SPAD arrays.

The system of any preceding or following implementation, wherein the image subsystem comprises: a first camera lens; a diffractive grating; a second camera lens; an ultrafast time gate; a third camera lens; and a 2D camera.

The system of any preceding or following implementation, wherein the image subsystem comprises: a first imaging arm comprising a lens and a linear SPAD array; a second imaging arm comprising a first camera lens; a diffractive grating; a second camera lens; an ultrafast time gate; a third camera lens; and a 2D camera; a flip mirror configured to switch a beam from the image compression subsystem to the first imaging arm to the second imaging arm and back.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A light field tomography fluorescence lifetime imaging microscopy (LIFT-FLIM) apparatus, comprising:
(a) an objective;
(b) a field stop;
(c) a fluorescence lifetime imager, said imager comprising:
(i) an array of Dove prisms configured to receive light from the field stop;
(ii) a plurality of lenslets, each lenslet optically coupled to at least one Dove prism of said array of Dove prisms;
(iii) a plurality of cylindrical lenses, said cylindrical lenses optically coupled to at least one lenslet; and
(iv) an image sensor configured to image light received from said cylindrical lenses.

2. The apparatus of claim 1, further comprising:
an excitation light source; and
a dichroic mirror disposed between said objective and said field stop.

3. The apparatus of claim 1, wherein said image sensor comprises one or more linear SPAD arrays.

4. The apparatus of claim 1, said image sensor further comprises:
a first camera lens;
a diffractive grating;
a second camera lens;
an ultrafast time gate;
a third camera lens; and
a 2D camera.

5. The apparatus of claim 1, further comprising:
a processor configured to control said lenses and imaging device; and
a non-transitory memory storing instructions executable by the processor;
wherein said instructions, when executed by the processor, perform steps comprising:
acquiring a dataset of image data from the fluorescence lifetime imaging device over time; and
analyzing the acquired dataset.

6. The apparatus of claim 5, wherein said instructions when executed by the processor further perform steps comprising:
controlling the target illumination light source; and
controlling the rate of image data acquisition.

7. A light field tomography fluorescence lifetime imaging microscopy (LIFT-FLIM) apparatus, comprising:
(a) a sample platform;
(b) an objective;
(c) image compression unit (ICU); and
(d) an image dispersion unit (IDU) optically coupled to the ICU.

8. The apparatus of claim 7, further comprising a field stop disposed between the objective and the image compression unit.

9. The apparatus of claim 7, wherein said image compression unit (ICU) comprises:
a scanning mirror;
a first lenslet;
a rotatable Dove prism configured to receive light from the field stop by the scanning mirror through the first lenslet;
a second lenslet optically coupled to the rotatable Dove prism; and
a cylindrical lens, said cylindrical lenses optically coupled to the second lenslet.

10. The apparatus of claim 7, wherein said image compression unit (ICU) comprises:
an array of Dove prisms configured to receive light from the field stop;
a plurality of lenslets, each lenslet optically coupled to at least one Dove prism of said array of Dove prisms;
a plurality of cylindrical lenses, said cylindrical lenses optically coupled to at least one lenslet; and
a slit array.

11. The apparatus of claim 7, wherein said image dispersion unit (IDU) comprises:
a first relay lens optically coupled to the slit array of the ICU;
a diffraction grating;
a second relay lens, said diffraction grating disposed between said first relay lens and said second relay lens; and
an imaging device.

12. The apparatus of claim 7, further comprising:
a processor configured to control said lenses and imaging device; and
a non-transitory memory storing instructions executable by the processor;
wherein said instructions, when executed by the processor, perform steps comprising:
controlling the target illumination light source; and
controlling the image compression unit (ICU);
controlling the image dispersion unit (IDU);
controlling the acquisition of data; and
analyzing an acquired dataset.

13. The apparatus of claim 12, wherein said processor further performs the step comprising:
displaying images derived from said analyzed dataset on a display.

14. A light field tomography fluorescence lifetime imaging microscopy (LIFT-FLIM) system, comprising:
(a) a sample excitation subsystem of a microscope objective, laser source and a field stop;
(b) an image compression subsystem of a scanning mirror, a first lens, a moveable dove prism, a second lens and a circular lens;
(c) an imaging subsystem with an image sensor;
(d) a processor configured to control said lenses and imaging device; and
(e) a non-transitory memory storing instructions executable by the processor;
(f) wherein said instructions, when executed by the processor, perform steps comprising:
(i) acquiring a dataset of image data from the imaging device over time; and
(ii) analyzing the acquired dataset.

15. The system of claim 14, wherein said sample excitation subsystem comprises:
a microscope objective;
a laser source of a pulsed laser, a diffuser, a first lens, a second lens; and an excitation filter;
a dichroic mirror; and
an emission filter.

16. The system of claim 15, said sample excitation subsystem further comprises:
a reference camera;
a beam splitter optically coupled to a lens and to an emission filter and to said reference camera configured to produce a reference intensity image; and
a scanning mirror.

17. The system of claim 14, wherein said image compression unit (ICU) comprises:
an array of Dove prisms configured to receive light from the field stop;
a plurality of lenslets, each lenslet optically coupled to at least one Dove prism of said array of Dove prisms;
a plurality of cylindrical lenses, said cylindrical lenses optically coupled to at least one lenslet; and
a slit array.

18. The system of claim 14, wherein said imaging subsystem comprises one or more linear SPAD arrays.

19. The system of claim 14, wherein said image subsystem comprises:
a first camera lens;
a diffractive grating;
a second camera lens;
an ultrafast time gate;
a third camera lens; and
a 2D camera.

20. The system of claim 14, wherein said image subsystem comprises:
a first imaging arm comprising a lens and a linear SPAD array;
a second imaging arm comprising a first camera lens; a diffractive grating; a second camera lens; an ultrafast time gate; a third camera lens; and a 2D camera;
a flip mirror configured to switch a beam from said image compression subsystem to said first imaging arm to said second imaging arm and back.
